(19) United States
(12) Patent Application Publication
(10) Pub. No.: US 2026/0326252 A1
(43) Pub. Date: Oct. 22, 2026

(54) DETERMINING A POSITION OF A TOOL IN A WORK AREA OF A BOND TESTER

(71) Applicant: XYZTEC B.V., Panningen (NL)

(72) Inventors: Cornelis Bartholomeus Maria VAN MIL, Panningen (NL); Sjoerd Catharina Maria MENNEN, Panningen (NL)

(21) Appl. No.: 19/110,390

(22) PCT Filed: Sep. 12, 2023
(86) PCT No.: PCT/NL2023/050463

§ 371 Date: Mar. 10, 2025

(30) Foreign Application Priority Data
Sep. 13, 2022 (NL) 2033017

(51) Int. Cl. B23Q 17/24; G01B 11/14; G06T 7/73

(52) U.S. Cl. CPC B23Q 17/2409; G01B 11/14; G06T 7/74

(57) ABSTRACT

A system for determining a the distance from tool to camera in a work area of a bond tester, comprising:
a light source positioned sidewards of the work area, configured to emit a light beam for illuminating the tool from the side;
a camera, positioned sidewards of the work area across of the light source, arranged to capture images of the light source and the tool;
a processor, communicatively coupled with the camera and configured for processing images received from the camera,
wherein in use the tool is positioned within the light beam that is emitted from the light source to the camera, and
wherein the processor is configured to determine positioning data of the tool by evaluating local differences in light intensity on the images captured by the camera while viewing the light source and the tool.

The present invention relates to a system for determining a position of a tool in a work area of a bond tester, as well as a method for doing the same.

A bond tester is a device that is used to test characteristics, e.g. bonding strength, of elements, such as contacts, mounted to a substrate, typically printed circuit boards. As the elements to be tested as well as the tools used therefore become smaller and smaller, it becomes more and more critical to determine the position of the tool with a high accuracy. Whereas previously a precision in the sub-millimeter range was deemed sufficient, nowadays accuracies of less than 1 nm may be required by operators of bond testers.

A current system to determine a relative position of a tool relies on a camera mounted above the work area of the tool, the tool itself, a reference point, an operator and a microscope. In the current system, the distance between the camera and the tool is (assumed to be) fixed. The camera mounted above the work area of the tool looks straight down and may be moved to a position above the reference point. A processor stores said relative position of the camera. Next, the tool is moved to a position above the reference point. This is done by an operator, who looks at the tool/reference point/work area with a microscope, and moves the tool until it is precisely above the reference point. The operator provides an input that the tool is above the reference point, and the relative position of the tool is also stored by the processor. By comparing the relative position of the tool when it is above the reference point to the relative position of the camera when it is above the reference point, the distance between the camera and the tool may be obtained. In use of the bond tester, each time a test is to be performed the camera is first positioned above the object to be tested (automatically), and then the tool is moved by the tool to camera distance, so that the tool is then above the object to be tested. The process of determining the tool to camera distance may be referred to as “calibration” of the bond tester.

This present system suffers from a few disadvantages. Although the tool to camera distances is assumed to be constant/fixed, in reality it is not. When the base to which both tool and camera are mounted is heated, this may vary the tool to camera distance with one or a few micrometres. Additionally, when another tool is put in place, this tool may have a slightly different position than the original tool, requiring a new calibration to determine the tool to camera distance again. Furthermore, the current system is relatively slow due to the fact that an operator has to perform the calibration while looking at the system through a microscope and the calibration may be imprecise/require an highly experienced operator.

It is an object of the present invention to improve at least one of these disadvantages.

Accordingly, a first aspect of the present invention relates to a system for determining a position of a tool in a work area of a bond tester, the system comprising:
a first light source positioned sidewards of the work area, and configured to emit a light beam for illuminating the tool from the side;
a side camera, positioned sidewards of the work area across of the first light source, the side camera arranged to capture images of the light beam and the tool directly or indirectly;
a processor, communicatively coupled with the side camera and configured for processing images received from the side camera,
wherein in use the tool is positioned within the light beam that is emitted by the first light source to the side camera, and
wherein the processor is configured to determine positioning data of the tool by evaluating local differences in light intensity on the images captured by the side camera while viewing the light beam and the tool.

In accordance with a first aspect of the present invention, a camera and a light source are placed at sides of the work area, the camera effectively looking at the light source and the light source effectively emitting a light beam towards the camera. In particular, the camera may be positioned directly in the light path of the light emitted by the light source, or mirrors may ensure that the camera is effectively positioned in the light path of the light emitted by the light source. Also the tool is positioned in the light path, the tool effectively being arranged in between the light source and the camera. As such a part of the light emitted by the light source is blocked by the presence of the tool, so that at the position of the tool a “shadow” is seen by the camera. From the image obtained by the camera, and by searching for the shadow a processor may determine the position of the tool, e.g. in absolute references or relative to another object. As such, compared to currently known systems the position of the tool may now be determined automatically, without requiring an operator who looks at the tool via a microscope and who moves the tool manually. This allows the position determination to not only be carried out faster, but also with greater precision.

In an embodiment, the system comprises a second light source positioned sidewards of the work area and configured to emit a light beam for illuminating the tool from the side, wherein one of the first and second light sources is substantially arranged along a lateral direction of the work area and wherein the other of the first and second light sources is substantially arranged along the longitudinal direction of the work area. In particular, the two light sources may be arranged at a 90 degree angle with respect to each other. Where a single camera may only be able to determine the position of the tool in one dimension, the use of two cameras may enable the system to determine the position of the tool in two dimensions, especially when the mutual position of the cameras is chosen wisely-such as at the mentioned 90 degree angle with respect to each other. As will be explained in the below, when using mirrors to manipulate the paths of the light beams emitted by the light sources it may be possible to view the tool twice in one camera image-so that only a single camera is needed to determine the position of the tool in two dimensions. Alternatively however the system may comprise two camera's, one associated with each of the light sources, wherein preferably each of the cameras determined the position of the tool in one dimension.

In an embodiment the system further comprises at least one mirror that is configured for reflecting the light beam emitted by the light source(s) towards the side camera. As will be explained in more detail in the below, when using a mirror efficiently it may be possible to catch the light emitted by both light sources with a single camera-so that the system may become more simple and less costly.

In an embodiment a field of view of the side camera is arranged at an angle compared to both the longitudinal and the lateral direction of the work area, the light beams emitted by the first and second light sources being emitted to the side camera indirectly. In this embodiment it may be possible to achieve substantially same object distances for both captured images, so that both images are sharp and can be processed with higher accuracy; leading to the tool position being determined with greater accuracy.

In an alternative embodiment the side camera is substantially arranged in the lateral or longitudinal direction of the work area, the light beam emitted by one of the light sources being sent to the side camera directly and the light beam emitted by the other of the light sources being sent to the side camera indirectly. Viewing at least one of the light sources directly has the advantage that the image cannot be obstructed by mirror imperfections and/or mirror deviations.

In an embodiment a length of the light path from the first light source to the side camera substantially equals a length of the light path from the second light source to the side camera. As explained in the above, this will lead to the sharpest image and the most accurate position determination.

In an embodiment the system further comprises a beam splitter, the beam splitter positioned in the light path of at least one of the light sources, the beam splitter arranged to selectively project the light of one of the two light sources on the side camera, e.g. in an alternating manner. In particular the provision of a beam splitter is advantageous when the system includes two light sources and relies on a single camera to capture the light of both of the light sources. The beam splitter may ensure that the images do not overlap, leading to the best result in terms of image sharpness and tool detection accuracy.

In an embodiment the side camera is configured as a reference side camera, preferably an automatic reference side camera. A reference camera may be able to directly calculate an absolute position of the tool, so that no relative position with respect to another element—that may be out of view—needs to be determined.

In an embodiment the side camera comprises a telecentric lens. Such lenses are best suited to capture the shadow of the tool with a minimum amount of distortion, leading to the clearest view and the most accurate position determination, independent of the distance between the lens and tool/the distance between the lens and the light source.

In an embodiment the light source is associated with a collimator, so that a collimated light beam is emitted from said light source. A collimated light beam will for this particular application lead to a minimum of distortion, so that the shadow of the tool may be best captured.

It is especially advantageous to use both a collimator for emitting a collimated light beam and a telecentric lens in front of the camera to catch the collimated light beam. This lead to the most clear view of the tool obstructing the light in a part of the image.

In an embodiment the light source emits light of a single wavelength, e.g. having a wavelength of in between 575 and 585 nm. When emitting light of a single wavelength, refraction of the light beam by the tool will be minimized. When using a CCD camera to capture the light and the tool, light with this particular wavelength leads to the most clear images, although other wavelengths may work sufficiently well.

In an embodiment the processor is further configured for obtaining tool dimensioning data by evaluating local differences in light intensity on the images captured by the at least one side camera while viewing the light source and the tool. In particular, the processor may determine a width of the tool and/or a tip shape of the tool based on the dimensioning data of the tool. This functionality allows the system to verify that a correct tool has been selected for the chosen task and/or to monitor wear and tear of the tool over time and/or evaluate and correct the concentricity of the tool.

In an embodiment the system further comprises a top camera associated with the tool, the top camera capturing images from the work area from above and being communicatively coupled with the processor, the processor further being configured to determine a relative position of the tool compared to the top camera based on an image of the reference point taken by the top camera and an image of the reference point and the tool taken by the side camera. When implementing a top camera in addition to a side camera, it may become possible to not only determine the position of the tool but also to determine the tool to (top) camera distance—but more accurately than before, so that in operation of the bond tester it is again this tool to top camera distance that may be used for rapid testing and it is not needed to determine the position of the tool before each test cycle. As such, the calibration with use of the side camera and the top camera may be done once or several times a day and/or each time a different tool is selected, relying on the tool to top camera distance when operating the bond tester.

A second aspect of the present invention relates to a bond tester comprising the system as described in the above. It is noted that the technical advantages that may be obtained with such a bond tester are the same as the technical advantages that may be obtained with the system that is described as the first aspect of the present invention.

A third aspect of the present invention relates to a method for determining a position of a tool of a bond tester, wherein use is made of a bond tester including the tool, the method comprising the steps of:
positioning the tool above a work area;
illuminating the tool with a light source that is arranged sidewards of the work area;
capturing images with a side camera, the side camera looking at the light source and the tool directly or indirectly and the side camera positioned sidewards of the work area, across of the light source so that the tool is placed in the light beam emitted of the light travelling from the light source to the camera;
processing images obtained with the camera by evaluating local differences in light intensity on the captured images to obtain positioning data of the tool.

It is noted that the technical advantages that may be obtained with such a method are the same as the technical advantages that may be obtained with the system that is described as the first aspect of the present invention and the bond tester that is described as the second aspect of the present invention.

These and other aspects of the present invention will now be elucidated with reference to the attached figures, wherein like or same elements have been indicated with the same reference numerals. In these figure:

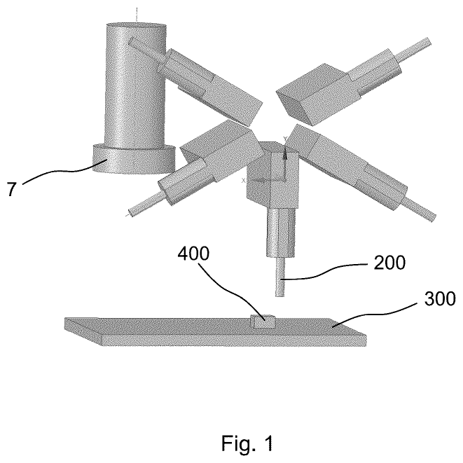

FIG. 1 schematically shows an isometric view of a bond tester as presently known, including a tool, a tool work area and a camera;

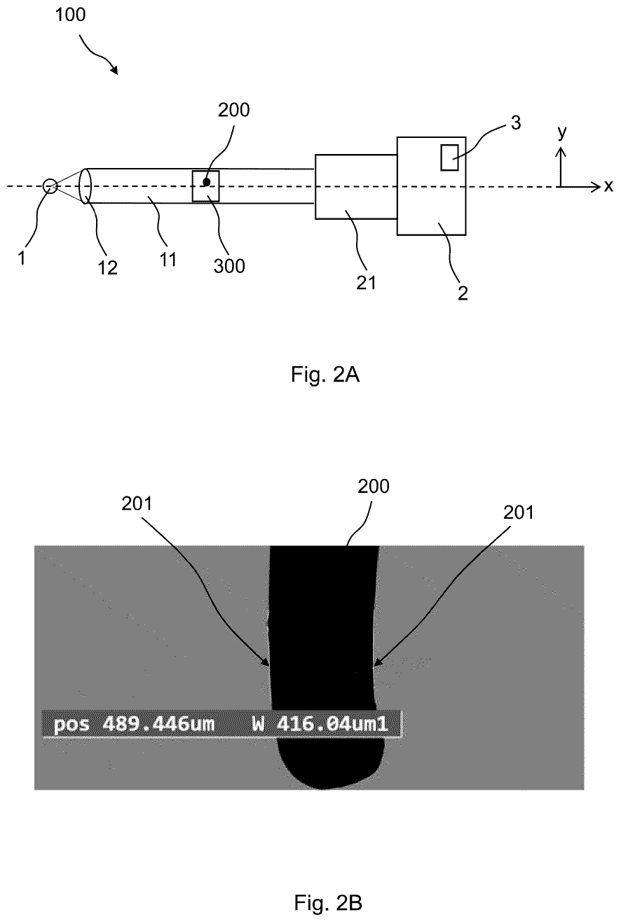

FIG. 2A schematically shows a top view of a first embodiment of a system for determining a position of a tool in a work area of a bond tester, in accordance with the present invention;

FIG. 2B schematically illustrates an image obtainable with the system of FIG. 2A;

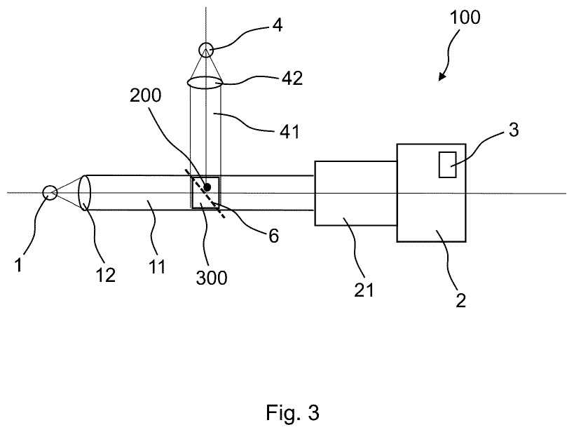

FIG. 3 schematically shows a top view of a second embodiment of a system for determining a position of a tool in a work area of a bond tester, in accordance with the present invention;

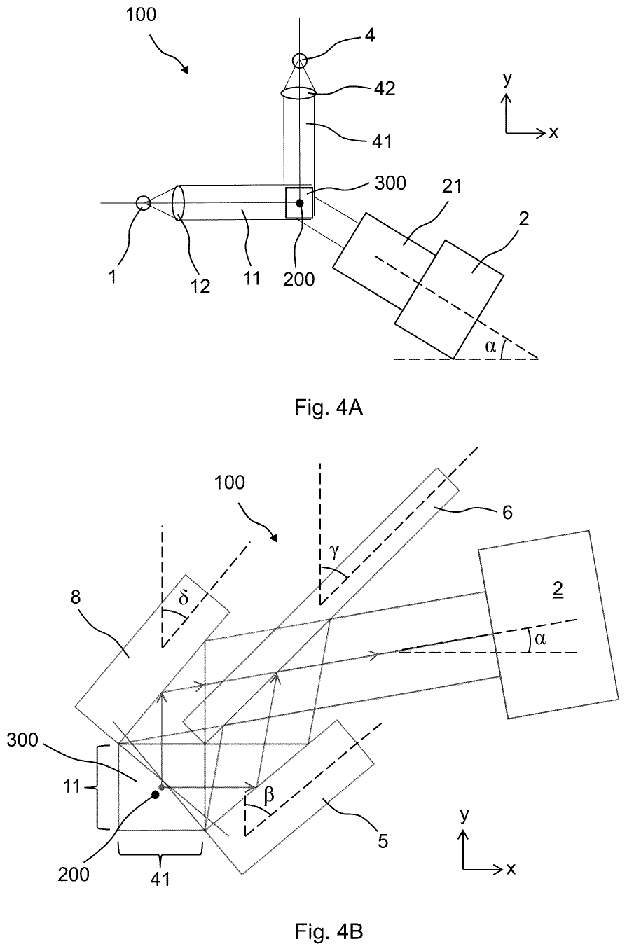

FIG. 4A schematically shows a top view of a third embodiment of a system for determining a position of a tool in a work area of a bond tester, in accordance with the present invention;

FIG. 4B schematically shows a more detailed view of the system as shown in FIG. 4A;

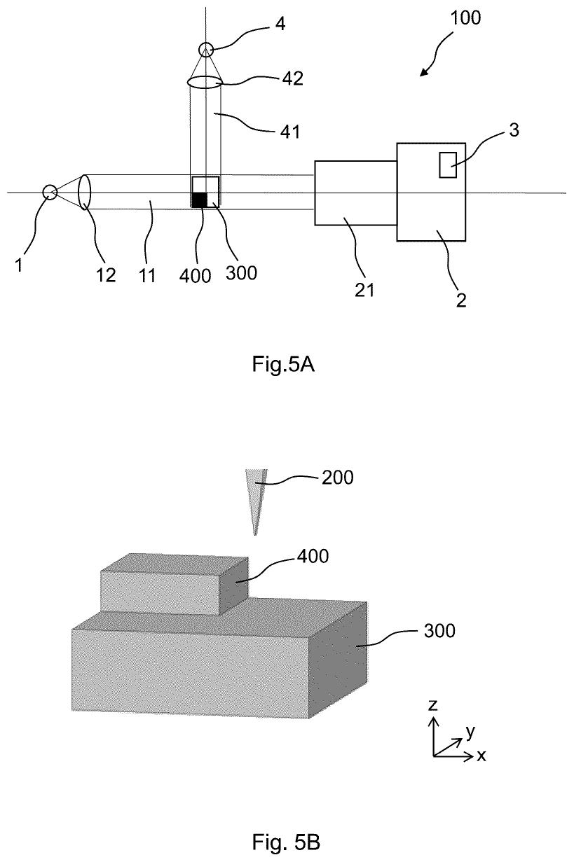

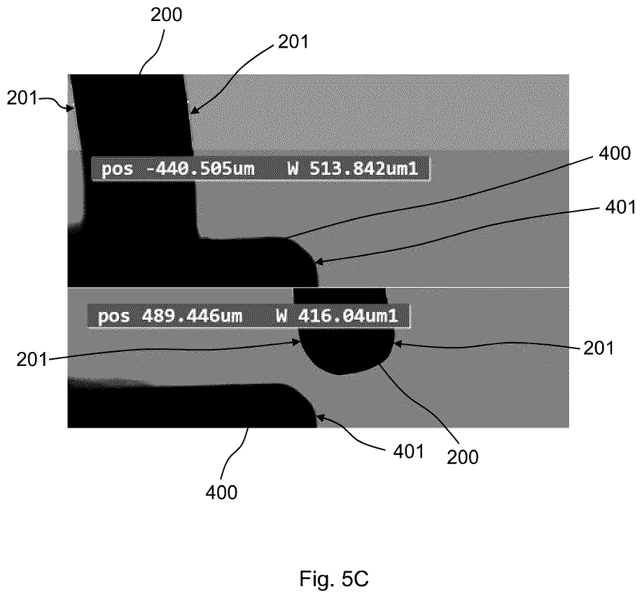

FIG. 5A schematically shows a top view of the system according to FIG. 3, with a reference present in the work area;

FIG. 5B schematically shows an isometric view of a work area, reference and a tool; and

FIG. 5C schematically shows images obtainable with the system set-up as shown in FIG. 5A.

FIG. 1 shows a portion of a bond tester as they are presently known. Shown is a set of tools 200, of which one points downwards towards a tool work area 300. By rotating the tools 200 about an axis that generally points into and out of the paper, a different tool 200 may be selected for test purposes. Further shown on the tool work area 300 is a reference 400, the reference 400 for calibration purposes as will be described in the below. The bond tester also includes a top camera 7. The top camera and the set of tools 200 are mounted to the same base; when one of them is moving the other of them is also moving. When the top camera 7 looks down, it can see what is right below it but not the tool. Hence, when one is performing a test with the tool 200 on an object to be tested in the work area 300, one is effectively working in the blind, i.e. without direct sight. Therefore, it is of the utmost importance that the bond tester is accurately calibrated. Calibration of the bond tester nowadays is generally carried out in the following manner. First the top camera 7 is moved until it is positioned above a reference 400. It can be determined when the top camera 7 is above the reference 400 by analysing the images captured by the top camera 7. Then the top camera 7 and set of tools 200 is moved until the tool 200 is above the reference 400. It can be determined when the tool 200 is above the reference 400 by looking at the work area 300 with a microscope. The movement distance (in both the lateral and the longitudinal direction) upon moving the tool 200 above the reference is tracked, from which movement distance the tool to camera distance may be obtained. The above process is known as calibrating the bond tester, resulting in a tool to camera distance. Each time a test should be performed, first the top camera 7 is positioned above the object to be tested, after which the top camera 7 and tool set 200 are moved by the tool to camera distance, thus assuming that after said movement the tool 200 is above the object to be tested. Preferably the calibration takes place at least each time a different tool 200 is selected, as well as on a daily basis. Disadvantages of this calibration method is that it is relatively slow and relies on human operators who may make mistakes and/or require training and experience.

Turning now to FIG. 2A, a new system 100 is shown in a top view, the system 100 allowing the absolute position of a tool 200 in a work area 300 to be obtained. It is noted that for the purpose of determining the relative position of the tool 200 with respect to the top camera 7, the effective work area 300 may be significantly smaller than the work area in which the tool may operate. In embodiments the effective work area 300 used for determining the relative position of the tool 200 with respect to the top camera overlaps with the tool work area. The system 100 relies upon a light source 1, a camera 2 and a processor 3. In contrast to the bond tester of the prior art that was described based on FIG. 1, the camera 1 of the new system 100 is placed sidewards of the work area 300 and in use illuminates the tool 200 from the side by emitting a light beam 11. The side camera 2 is also placed sidewards of the work area 300, across of the light source 1 and looks at the tool 200 and light source 1 so that it captures the light emitted by the light source 1. As such, when looking at the light path of the light beam 11 from light source 1 to camera 2, the tool 200 is placed inside said light beam 11. Preferably, the light source 1 may be associated with a collimator 12, so that a collimated light beam is emitted by the light source 1. Further preferably, the camera comprises a telecentric lens 21 and is operated as an automatic reference camera. Especially in this setup, when the camera 2 looks at the tool 200 and the light source 1, the tool 200 will block the light beam 11 emitted by the light source 1 so that the image captured by the camera 2 has different light intensities depending on the position of the tool 200. A view of the camera image obtained in this way is shown in FIG. 2B, wherein edges 201 of the tool 200 are clearly visible, so that the position of the tool 200 may be determined, automatically, by a processor associated with the camera 2. Note that in the setup as shown in FIG. 2A, the camera 2 looks directly at the tool 200, work area 300 and light source 1, without any interim mirrors or the like.

As may be appreciated from FIG. 2B, the image obtained in this way may be so sharp that and accurate that it may even be possible to determine tool dimensioning data from the evaluation of local differences in light intensity-opening the door towards predictive tool maintenance programs and checks regarding correctness of tool selection.

Whereas the schematic setup illustrated in FIG. 2A allows the position of the tool 200 to be determined in one direction (say, the longitudinal direction), and is oriented in said direction, it might be required that a second light source is added to the system 100 to also determine the position of the tool 200 in another direction (say, the lateral direction). Whereas the most easy solution might be to add another light source and another camera, e.g. in the manner and with the configuration as shown in FIG. 2A, in said other direction, leading to a system with two light sources and two camera's, such a system might become relatively expensive and resulting in further calibration problems between the two camera's.

Using one or more mirrors, it may be possible to project the light emitted by a first and a second light source onto the lens of a single camera. Two such systems 100 are shown in FIGS. 3 and 4A.

In the system 100 that is shown in FIG. 3 a second light source 4, again with a collimator 42 associated with it, is added compared to the setup of FIG. 2A. Compared to the first light source 1, that is arranged along the longitudinal direction of the work area 300, the second light source 4 is arranged at a perpendicular orientation so that the second light source 4 is arranged along the lateral direction of the work area 300. As such, also the second light source 4 is positioned sidewards of the work area 300 and illuminates the tool 200. As is shown in more detail, the light emitted by the second light source 4 is reflected by a mirror and a beam splitter 6 and projected into the lens of the camera 2 while the light emitted by the first light source 1 can pass through the beam splitter 6. In the present embodiment the beam splitter 6 is, for that purpose, arranged at a 45 degree angle with respect to the horizontal/lateral direction. However, one skilled in the art will understand that other configurations are well possible, especially when more than one mirror would be used. As such, the camera 2 received the light emitted by the first light source 1 directly and the light emitted by the second light source 4 indirectly.

A minor disadvantage of the setup shown in FIGS. 3A and 3B is that the light path from the first light source 1 to the camera 2 may shorter than the light path from the second camera 4 to the camera 2. This may lead to an unclear picture of the tool 200 on the image captured by the camera 2. Furthermore, positioning of the light sources 1, 4 and camera 2 may be relatively challenging as the system 100 shown in FIG. 3 should position the beam splitter 6 behind the tool 200 with respect to the second light source 4 and in front of the tool 200 with respect to the first light source 1. This leads to a small useful work area. To account for those relative disadvantages, the system 100 as shown in FIGS. 4A and 4B may be used.

As schematically shown, the system 100 of FIG. 4A comprises two light sources 1, 4, each illuminating the tool 200 in the work area 300 from one side. Each of the light sources 1, 4 is associated with a collimator 12, 42 so that they emit a collimated light source 11, 41. The system 100 further comprises a single camera 2, arranged sidewards of the work area 300 and generally opposite of the first and second light source 1, 4. The camera 2 is arranged at an angle α with respect to the longitudinal axis X of the work area 300.

Shown on the lefthand-side of the figure is an incoming light beam 11, emitted by the first light source 1. The light beam 11 illuminates the tool 200 and is reflected by a first mirror 5. In the example shown here, the first mirror 5 is arranged at an angle β with respect to the lateral direction, the angle β having a magnitude of 50 degrees. As the angle of entrance equals the angle of exit, the light beam 11 leaves the first mirror 5 at an orientation of 10 degree with respect to the lateral direction Y. It is subsequently reflected by a beam splitter 6 that is in the shown example embodiment arranged at an angle γ having an orientation of 45 degree with respect to the lateral orientation Y. This ensures that the light beam 11 leaves the beam splitter 6 at an orientation of 10 degree with respect to the longitudinal direction X. In the shown embodiment, the field of view of the camera 2 is also oriented at an orientation of 10 degrees with respect to the longitudinal direction, so that the light beam 11 is received by the lens of the camera 2 as if the camera 2 is looking straight at the light source 1 (as in FIG. 2A).

Following the path of the second light beam 41, which enters at the bottom of the figure, the second light beam 41 initially illuminates the tool 200 and is reflected by a second mirror 8. In the example shown here, the second mirror 8 is arranged at an angle δ with respect to the lateral direction, the angle δ having a magnitude of 40 degrees. As the angle of entrance equals the angle of exit, the second light beam 41 leaves the second mirror 8 at an orientation of 10 degree with respect to the horizontal direction X—the same orientation as the first light beam 11 after it is reflected by both the mirror 5 and the beam splitter 6. The second light beam 41 subsequently encounters a beam splitter 6, which allows the light beam to pass through it without affecting its properties. This ensures that also the second light beam 41 exits the beam splitter 6 at an orientation of 10 degree with respect to the longitudinal direction X and into the camera 2.

With the setup as shown the light beams 11, 41 may overlap. However, all sorts of beam splitters 6 are available, so that it is e.g. possible to allow only one half of the light beam 11, 41 to be passed/reflected by the beam splitter 6 so that one half of the camera lens 21 views the image of one of the light sources and the other half of the camera lens views the image of the other of the light sources. Further alternatively, the light sources may be switched on and off alternatingly, so that the images of the two light sources are received alternatingly.

As may be appreciated, with the setup shown in FIGS. 4A and 4B the light paths of the light beams 11, 41 from the first light source 1 to the camera 2 and from the second light source 4 to the camera 2 are substantially equally long.

Although the above-shown embodiment has a specific setup, in general one can say that it is desirable when both the light beam 11 emitted by the first light source 1 and the light beam 41 emitted by the second light source 4 are projected onto the lens of the camera 2 at the same angle, the lens of the camera 2 being arranged perpendicular to said angle, so that it is as if the camera 2 is looking straight into the light sources 1, 4. In general terms, this can be accomplished by using a setup as shown in the above, with one mirror 5, 8 at the opposite end of the work area compared to where the light beam 11, 41 is incoming, determining the desired mounting angle α of the camera 2, and mounting the first mirror 5 at an angle of 45 degrees−½ α, the second mirror 5, 8 at an angle of 45 degrees+½ α and a beam splitter 6 at a position in the light path after the light beams 11, 41 have been reflected by the first and second mirrors 5, 8 at a 45 degree orientation. However, as is evidenced by the embodiment shown in FIG. 3A, also other setups may be conceived which lead to the same desired effect of using a single camera 2, two light sources 1, 4 and reflecting the light beams 11, 41 emitted by the light sources 1, 4 into the camera 2.

The systems 100 shown in FIGS. 2, 3 and 4 allow to obtain a position of a tool 200 directly and automatically. As the position of an object to be tested by the tool on the work area 300 is not always known, it may still be essential to determine the tool to camera distance—wherein it is noted that the tool to camera distance, still, refers to the distance between a top camera of the bond tester and a tool of the bond tester, and not the distance between a side camera of the system as explained herein and the tool. To obtain this tool to camera distance with the system as disclosed herein, it may be required to position the tool, the side camera and the top camera near a reference 400 on a work area 300—see FIGS. 5A, 5B and 5C. It is noted that in FIG. 5A the configuration of the two light sources 1, 4 and the camera 2 is the same as in FIGS. 3A and 3B, but that now a reference 400 is visible in the work area 300 instead of a tool 200. As the system is shown in a top view, the top camera that was e.g. shown on FIG. 1 is not visible here. To obtain the tool to camera distance the top camera is positioned above a center position of the reference 400. With the top camera above the reference 400, the coordinates of the tool 200 may be obtained and stored by the processor 3 associated with the side camera 2. In a second step (that may optionally be caried out as a first step) the tool 200 is positioned above or near the reference 400, at which position the coordinates of the tool 200 are again obtained and stored by the side camera 2. From these two measurements the tool to camera distance can be obtained, possibly after accounting for a misalignment of the tool 200 above the reference 400 by obtaining the positions of and distance between the edges 401 of the reference 400 and the edge 201 of the tool 200. Advantageously, in the second step one has visual proof that the tool 200 was indeed positioned right above the reference 400. Advantageously, when using image recognition techniques, the above-described technology allows one to compute the tool to camera distance without the involvement of an operator.

LIST OF REFERENCE NUMERALS

| | |
|---|---|
| 1 | first light source |
| 11 | light beam |
| 12 | collimator |
| 2 | side camera |
| 21 | telecentric lens |
| 3 | processor |
| 4 | second light source |
| 41 | light beam |
| 42 | collimator |
| 5 | mirror |
| 6 | beam splitter |
| 7 | top camera |
| 8 | mirror |
| 100 | system |
| 200 | tool |
| 201 | tool edge |
| 300 | work area |
| 400 | reference |
| 401 | reference edge |
| α | angle between field of view of the side camera and the longitudinal |
| | direction |
| β | angle between orientation first mirror and lateral direction |
| γ | angle between orientation beam splitter and lateral direction |
| δ | angle between orientation second mirror and lateral direction |

1. A system for determining a position of a tool in a work area of a bond tester, the system comprising:
a first light source positioned sidewards of the work area, and configured to emit a light beam for illuminating the tool from the side;
a side camera, positioned sidewards of the work area across of the first light source, the side camera arranged to capture images of the light beam and the tool directly or indirectly;
a processor, communicatively coupled with the side camera and configured for processing images received from the side camera,
wherein in use the tool is positioned within the light beam that is emitted by the first light source to the side camera, and
wherein the processor is configured to determine positioning data of the tool by evaluating local differences in light intensity on the images captured by the side camera while viewing the light beam and the tool.

2. The system according to claim 1,
wherein the system comprises a second light source positioned sidewards of the work area and configured to emit a light beam for illuminating the tool from the side,
wherein one of the first and second light sources is substantially arranged along a lateral direction of the work area and wherein the other of the first and second light sources is substantially arranged along the longitudinal direction of the work area.

3. The system according to claim 2, further comprising at least one mirror that is configured for reflecting the light beam emitted by the light source(s) towards the side camera.

4. The system according to claim 3, wherein a field of view of the side camera is arranged at an angle compared to both the longitudinal and the lateral direction of the work area, the light beams emitted by the first and second light sources being emitted to the side camera indirectly.

5. The system according to claim 3, wherein the side camera is substantially arranged in the lateral or longitudinal direction of the work area, the light beam emitted by one of the light sources being sent to the side camera directly and the light beam emitted by the other of the light sources being sent to the side camera indirectly.

6. The system according to claim 2, wherein a length of the light path from the first light source to the side camera substantially equals a length of the light path from the second light source to the side camera.

7. The system according to claim 2, wherein the system further comprises a beam splitter, the beam splitter positioned in the light path of at least one of the light sources, the beam splitter arranged to selectively project the light beam of one of the two light sources on the side camera.

8. The system according to claim 1, wherein the side camera is configured as a reference side camera, preferably an automatic reference side camera.

9. The system according to claim 1, wherein the side camera comprises a telecentric lens.

10. The system according to claim 1, wherein the light source is associated with a collimator, so that a collimated light beam is emitted from said light source.

11. The system according to claim 1, wherein the light source emits a light beam having light with a single wavelength, for example a wavelength of in between 575 and 585 nm.

12. The system according to claim 1, wherein the processor is further configured for obtaining tool dimensioning data by evaluating local differences in light intensity on the images captured by the at least one side camera while viewing the light beam and the tool.

13. The system according to claim 1, further comprising a top camera associated with the tool, the top camera capturing images from the work area from above and communicatively coupled with the processor, the processor further being configured to determine a relative position of the tool compared to the top camera based on:
an image of the reference point taken by the top camera; and
an image of the reference point and the tool taken by the side camera.

14. The system of claim 1, wherein the system is integrated into bond tester.

15. A method for determining a position of a tool of a bond tester, wherein use is made of a bond tester including the tool, the method comprising the steps of:
positioning the tool above its work area;
illuminating the tool with a light source that is arranged sidewards of the work area by emitting a light beam towards said tool;
capturing images with a side camera, the side camera looking at the light beam and the tool directly or indirectly and the side camera positioned sidewards of the work area, across of the light source so that the tool is placed in the light beam emitted by the light source to the side camera;
processing images obtained with the side camera by evaluating local differences in light intensity on the captured images to obtain positioning data of the tool.
